(19) United States
(12) Patent Application Publication
(10) Pub. No.: US 2016/0289069 A1
(43) Pub. Date: Oct. 6, 2016

(54) System To Produce Gaseous Hydrogen

(71) Applicants: Ujjval Vyas, Chicago, IL (US); John Kriegshauser, Chicago, IL (US); Alan Bath, Chicago, IL (US)

(72) Inventors: Ujjval Vyas, Chicago, IL (US); John Kriegshauser, Chicago, IL (US); Alan Bath, Chicago, IL (US)

(21) Appl. No.: 14/676,401

(22) Filed: Apr. 1, 2015

(51) Int. Cl. C01B 3/10; B01J 19/18; B01J 19/00

(52) U.S. Cl. CPC C01B 3/10; B01J 19/0066; B01J 19/18; B01J 2219/00761

(57) ABSTRACT

A system for the capture and extraction of hydrogen gas. The system contains a metallic or semi-metal material placed inside a containment vessel. A solution of H₂O is added to the containment vessel creating a chemical reaction between the metallic or semi-metal material within the containment vessel. The chemical reaction creates the byproduct of a hydrogen gas as well as impurities. A stirring mechanism is placed into the containment unit and it is contact with the metallic or semi-metal material. The stirring mechanism is operative to remove the impurities from the chemical reaction from the surface of the metallic or semi-metal material without damaging or removing the metallic or semi-metal material itself. The byproduct of hydrogen gas then flows through a hydrogen extraction point located on the containment vessel for collection or operational use.

### FIELD OF DISCLOSURE

The present disclosure relates to a system and method of producing and collecting hydrogen gas, and particularly a wiping device which removes impurities from the surface of a reactive metallic or semi-metal material to allow for collection of hydrogen gas by the system.

### BACKGROUND OF THE DISCLOSURE

Hydrogen gas in by far the most plentiful element in the universe. Hydrogen is the ultimate power source, powering the massive stars that dot the vastness of space. Hydrogen is also an essential element for life; water (H₂O) makes up a large part of most living animals and organisms.

Though plentiful throughout the universe, hydrogen is not plentiful in its gaseous form here on earth. The majority of hydrogen that one encounters day to day is chemically bonded to oxygen in water. Breaking this bond and obtaining hydrogen in its elemental form allows for a multitude of uses, and elemental hydrogen is employed in many industries. Originally, because of its low density, hydrogen was the ideal choice for filling airships and balloons for travel and other endeavors. However because of hydrogen's extreme reactivity in the presence of oxygen, this practice largely came to an end in the late 1930's.

In the chemical industry, hydrogen is often used to make ammonia for agricultural fertilizer. Hydrogen is also used in the production of plastics and pharmaceuticals, and is an important element used in oil-refining processes. In the food industry, hydrogen can form hydrogenated oils from fats for uses in butter substitutes like margarine. In electronics, hydrogen provides an excellent flushing gas during the manufacture of silicon chips.

Perhaps of the greatest current interest, hydrogen has been described as the fuel of the future and this appears to be true. Producing energy with the use of hydrogen fuel cells, hydrogen leaves no harmful byproducts as it returns to water when it oxidizes. Similarly, the combustion of Hydrogen in an internal combustion engine leaves only water as a byproduct.

Although hydrogen has a multitude of consumer and industrial uses, it is still challenging to effectively and efficiently refine hydrogen. Known methods for producing hydrogen gas include steam reformation (e.g., with a hydrocarbon feed stock) and electrolysis. Steam reforming to produce hydrogen is the most popular method of hydrogen production. Steam reforming involves reacting steam (H₂O) with methane (CH₄) in an endothermic reaction to yield syngas, a fuel gas mixture consisting primarily of hydrogen, carbon monoxide, and some carbon dioxide.

As noted, an alternative process for generating gaseous hydrogen is referred to as electrolysis. During electrolysis, hydrogen is produced via an electric current in water. The current disassociates the hydrogen from oxygen to produce gaseous hydrogen. While reformation and electrolysis are frequently used, other methods of producing gaseous hydrogen are available as well.

While the present disclosure is directed to a system that can eliminate some of the shortcomings noted in this Background section, it should be appreciated that any such benefit is not a limitation on the scope of the disclosed principles, or of the attached claims, except to the extent expressly noted in the claims. Additionally, the discussion of technology in this Background section is reflective of the inventors' own observations, considerations, and thoughts, and is in no way intended to accurately catalog or comprehensively summarize the prior art. As such, the inventors expressly disclaim this section as admitted or assumed prior art with respect to the discussed details. Moreover, the identification herein of a desirable course of action reflects the inventors' own observations and ideas, and should not be assumed to indicate an art-recognized desirability.

### SUMMARY OF THE DISCLOSURE

In accordance with one aspect of the disclosure, a stirring mechanism for use in a system to collect hydrogen gas is disclosed. The stirring mechanism has a top connection attached to a rotational device. The rotational device is powered to rotate the stirring mechanism. A stirring mechanism also has a shaft portion protected by a barrier. The barrier extends the length of the shaft portion of the stirring mechanism. A wiping device is attached to a bottom of the stirring mechanism and positioned to be in contact with a metallic or semi-metal material when the stirring mechanism rotates. The wiping device operates to remove an impurity buildup on a surface of the metallic or semi-metal material without damaging or removing the surface of the metallic or semi-metal material.

In an additional and/or alternative embodiment of any of the foregoing embodiments, the wiping device has a cleaning instrument attached to the wiping device.

In an additional and/or alternative embodiment of any of the foregoing embodiments, the cleaning instrument is a fabric pad, bristles, or a wiping blade.

In an additional and/or alternative embodiment of any of the foregoing embodiments, the metallic or semi-metal material has a cavity or a plurality of cavities formed into the metallic or semi-metal material. The cavity or the plurality of cavities being formed to contain a caustic.

In an additional and/or alternative embodiment of any of the foregoing embodiment, the wiping device is formed from a support beam attached to the shaft portion of the stirring mechanism and a plurality of prongs extend downward from the support beam.

In an additional and/or alternative embodiment of the foregoing embodiment, wherein a cleaning instrument is attached to the plurality of prongs of the wiping device and a bottom portion of the support beam.

In an additional and/or alternative embodiment of any of the foregoing embodiments, the wiping device is formed from a support beam attached to the shaft portion of the stirring mechanism. A cleaning instrument is attached to a bottom portion of the support beam and hangs in a vertically downward fashion.

In an additional and/or alternative embodiment of any of the foregoing embodiments, the wiping device is formed in a support whisk shape. The support whisk shape having a cleaning instrument attached to a plurality of whisk loops forming the support whisk shape.

In an additional and/or alternative embodiment of any of the foregoing embodiments, the wiping device is formed by a supporting cylinder insert. The supporting cylinder insert having a shaft extension traveling from the bottom of the shaft of the stirring mechanism to a circular base of the supporting cylinder insert. The circular base of the supporting cylinder insert having an outer wall attached to the circumference of the circular base of the supporting cylinder insert and extending upward and a cleaning instrument attached to the circular base of the supporting cylinder insert and an inward facing surface of the outer wall.

In an additional and/or alternative embodiment of any of the foregoing embodiments, the wiping device is formed from a large surface area cleaning instrument, the large surface area cleaning instrument connects to the shaft portion of the stirring mechanism by a plurality of connection strands and is configured to suspend the metallic or semi-metal material by gravity within the large surface area cleaning instrument.

In an additional and/or alternative embodiment of any of the foregoing embodiments, the wiping device is formed by a supporting fan insert, the supporting fan inset having a shaft extension traveling from the bottom of the shaft of the stirring mechanism to a plurality of fan blades positioned at the bottom of the shaft extension extending radially outward from the shaft extension. The plurality of fan blades configured to angle upward from the base of the shaft extension and an outer support ring connecting the plurality of fan blades of the supporting fan to the circular base of the supporting cylinder insert.

In accordance with another aspect of the disclosure, a system to extract and capture hydrogen gas is disclosed having a first containment vessel. The first containment vessel has a hydrogen extraction point. A solution of H₂O fills at least part of an interior of the first containment vessel. A metallic or semi-metal material is placed inside the interior of the first containment vessel and covered by the solution of H₂O. A surface of the metallic or semi-metal material chemically reacts with the solution of H₂O producing at least a hydrogen gas byproduct. A stirring mechanism is disposed into the interior of the first containment vessel and into the solution of H₂O. The stirring mechanism has a top connection. A shaft portion of the stirring mechanism extends from the top connection to a bottom connection of the stirring mechanism. A wiping device is attached to the bottom connection of the stirring mechanism and the wiping device is positioned to be in contact with a metallic or semi-metal material when the stirring mechanism rotates. The wiping device operates to remove an impurity buildup on a surface of the metallic or semi-metal material without damaging or removing the surface of the metallic or semi-metal material.

In an additional and/or alternative embodiment of any of the foregoing embodiments, the first containment vessel has a top portion and a bottom portion. The bottom portion being solid and part of the first containment vessel and the top portion having a covering device to enclose the first containment vessel.

In an additional and/or alternative embodiment of any of the foregoing embodiments, the shaft portion of the stirring mechanism is protected by an insulation barrier. The insulation barrier extends the length of the shaft portion of the stirring mechanism from the covering device of the top portion of the first containment vessel to below the highest point of the solution of H₂O within the first containment vessel.

In an additional and/or alternative embodiment of any of the foregoing embodiments, the stirring mechanism extends through the covering device of the top portion of the first containment vessel.

In an additional and/or alternative embodiment of any of the foregoing embodiments, the hydrogen extraction point is positioned in the covering device of the top portion of the first containment vessel and operable to allow the hydrogen gas byproduct to flow through the hydrogen extraction point and into a remote collection chamber or a hydrogen operable device.

In an additional and/or alternative embodiment of any of the foregoing embodiment, the solution of H₂O contains at least water and a caustic.

In an additional and/or alternative embodiment of any of the foregoing embodiments, the top connection of the stirring mechanism attaches to a rotational device powered to turn the stirring mechanism within the solution of H₂O inside the first containment vessel. The wiping device powered by the rotational device removes the impurity buildup on the surface of the metal or semi-metal material when the stirring mechanism rotates.

In an additional and/or alternative embodiment of any of the foregoing embodiments, a second containment vessel is disposed remotely from the first containment vessel. The second containment vessel is connected to the first containment vessel by a tubular connection. The tubular connection allows for the flow of the solution of H₂O between the first containment vessel and the second containment vessel.

In accordance with another aspect of the disclosure, a method of extracting and capturing hydrogen gas is disclosed. First, a metallic or semi-metal material is added to an interior portion of a containment vessel. A stirring mechanism is then placed within the interior portion of the containment vessel above the metallic or semi-metal material. Then, a covering portion is disposed on a top portion of the containment vessel. The covering portion seals the metallic or semi-metal material within the interior of the containment vessel and the covering portion has an input available to receive a solution of H₂O. Then, the solution of H₂O is added through the input of the covering portion of the containment vessel filling at least a portion of the containment vessel. A chemical reaction is produced between the metallic or semi-metal material and the solution of H₂O creating hydrogen gas and an impurity byproduct. A rotational device is activated and attached to a top portion of the stirring mechanism to rotate the stirring mechanism. The metallic or semi-metal material is wiped with a wiping device. The wiping device is attached to the bottom portion of the stirring mechanism and is in contact with the metallic or semi-metal material. When the wiping devices rotate, the wiping device removes the impurity byproducts from a surface of the metallic or semi-metal material without damaging or removing the surface of the metallic or semi-metal material. Finally, the hydrogen gas from the chemical reaction is extracted through a hydrogen extraction point disposed in the covering portion of the containment vessel.

These and other aspects and features will be better understood when taken in conjunction with the following drawings.

### BRIEF DESCRIPTION OF THE DRAWINGS

FIG. 1 is an overview of a system to produce gaseous hydrogen in accordance with an embodiment of the present disclosure.

FIG. 2 is a perspective view of a stirring mechanism used in the system to produce gaseous hydrogen in accordance with an embodiment of the present disclosure.

FIG. 3 is a view of a wiping device above a cross-sectional view of a metallic or semi-metal material used in the system to produce gaseous hydrogen in accordance with an embodiment of the present disclosure.

FIG. 4 is perspective view of a wiping blade attachment of the wiping device and metallic or semi-metal material used in a system to produce gaseous hydrogen in accordance with an embodiment of the present disclosure.

FIG. 5 is perspective view of a bristle attachment of the wiping device and metallic or semi-metal material used in a system to produce gaseous hydrogen in accordance with an embodiment of the present disclosure.

FIG. 6 is perspective view of a wiping pad attachment of the wiping device and metallic or semi-metal material used in a system to produce gaseous hydrogen in accordance with an embodiment of the present disclosure.

FIG. 7 is perspective view of a long thin bristle attachment of the wiping device and metallic or semi-metal material used in a system to produce gaseous hydrogen in accordance with an embodiment of the present disclosure.

FIG. 8 is a view of a wiping blade attachment attached as part of the shaft section of the stirring mechanism and metallic or semi-metal material used in a system to produce gaseous hydrogen in accordance with an embodiment of the present disclosure.

FIG. 9 is a view of a bristle attachment attached as part of the shaft section of the stirring mechanism and metallic or semi-metal material used in a system to produce gaseous hydrogen in accordance with an embodiment of the present disclosure.

FIG. 10 is a perspective view of a long strands of fabric wiping device and containment vessel used in a system to produce gaseous hydrogen in accordance with an embodiment of the present disclosure.

FIG. 11 is a perspective view of a whisk shaped wiping device and containment vessel used in a system to produce gaseous hydrogen in accordance with an embodiment of the present disclosure.

FIG. 12 is a perspective view of a suspension type wiping device and containment vessel used in a system to produce gaseous hydrogen in accordance with an embodiment of the present disclosure.

FIG. 13 is a perspective view of a fabric coated insert wiping device and containment vessel used in a system to produce gaseous hydrogen in accordance with an embodiment of the present disclosure.

FIG. 14 is a perspective view of a fan type wiping device and containment vessel used in a system to produce gaseous hydrogen in accordance with an embodiment of the present disclosure.

FIG. 15 is a top down perspective of the fan type wiping device removed from the containment vessel in accordance with an embodiment of the present disclosure.

FIG. 16 is a flowchart that exemplifies one method to produce gaseous hydrogen using the system in accordance with an embodiment of the present disclosure.

It should be understood that the drawings are not necessarily to scale and that the disclosed embodiments are illustrated diagrammatically and in partial views. It should be further understood that this disclosure is not to be limited to the particular embodiments illustrated herein.

### DETAILED DESCRIPTION OF THE PRESENTLY PREFERRED EMBODIMENTS

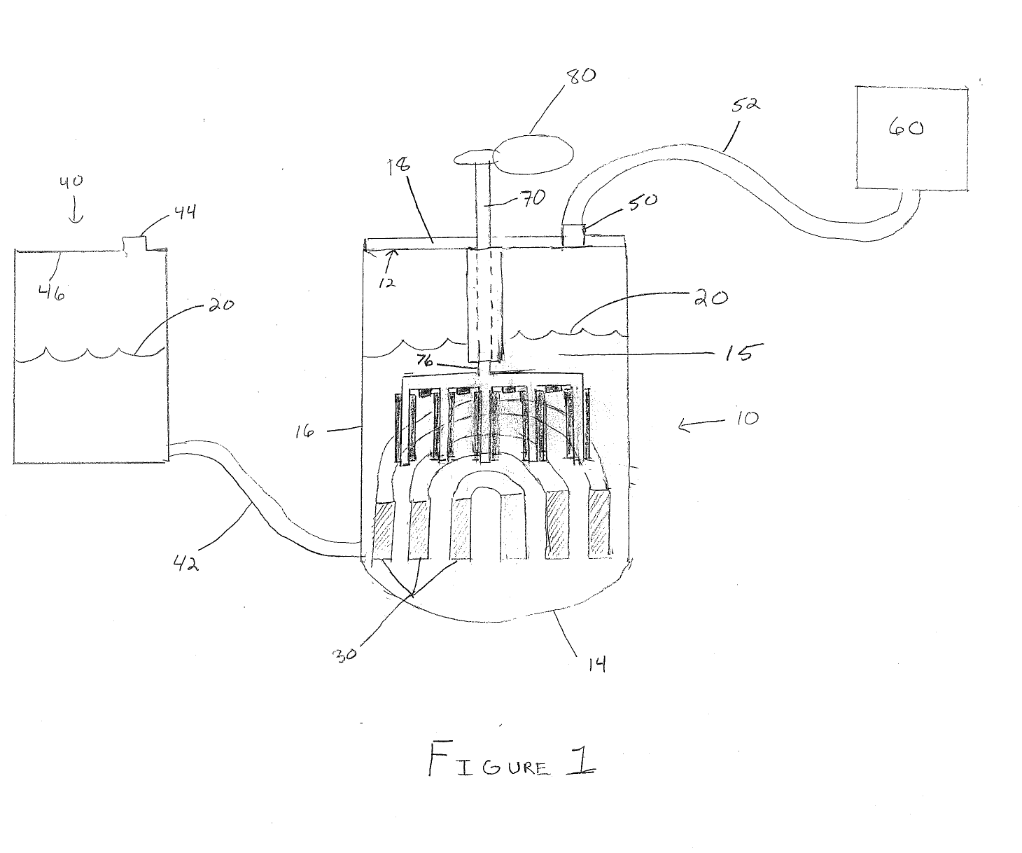

FIG. 1 illustrates a schematic overview of a hydrogen generation and collection system in keeping with an embodiment of the described principles. A first containment vessel 10 is included into which additional elements are placed. The first containment vessel 10 has at least a top portion 12 and a bottom portion 14 in an embodiment, and takes any of a multitude of cross-sectional shapes including but not limited to a cylinder, square, rectangle, or triangle.

The bottom portion of the first containment vessel 14 is attached to the sides of the first containment vessel 16. The top portion of the first containment vessel 12 is, in this embodiment, either open or in contact with the sides of the first containment vessel 16. Additionally, the top portion of the first containment vessel 12 is fashioned from a covering device 18. This covering device 18 is a lid, cap, canopy or seal or the like placed on the top portion of the first containment vessel 12 and attached to the sides of the first containment vessel 16.

A solution of H₂O 20 is placed inside the first containment vessel 10 in an embodiment of the disclosed principles. This solution of H₂O 20 includes H₂O as well as a caustic. The caustic is any of a variety of caustic substances, and is introduced into the solution of H₂O 20 in either a liquid or solid form. If introduced in a solid form, the caustic has the ability to dissolve into the solution of H₂O 20 as to adequately disperse the caustic throughout the solution of H₂O 20. One caustic used is NaOH, however a variety of other caustics which react with the below described metallic or semi-metal material 30 can be used. The solution of H₂O 20 which is placed inside the first containment vessel 10 fills at least part of the interior of the first containment vessel 15.

Additionally inside the first containment vessel 10 a metallic or semi-metal material 30 is placed inside the interior of the first containment vessel 15. The metallic or semi-metal material 30 is placed inside the first containment vessel 10 in such a fashion so that the solution of H₂O 20 adequately covers the metallic of semi-metal material 30. The metallic or semi-metal material 30 is a material which chemically reacts with the solution of H₂O 20 to produce at least a hydrogen gas byproduct. Examples of such metallic or semi-metal materials 30 include but are not limited to aluminum, ferrosilicon, copper, iron, magnesium, and zinc.

A second containment vessel 40 is disposed remotely from the first containment vessel 10. The second containment vessel 40 is connected 42 to the first containment vessel 10 in such a fashion as to allow for the solution of H₂O 20 to freely flow between the two vessels. Such a connection 42 is made with a tube, or another linking agent which sufficiently connects the two vessels while adequately protecting and not inhibiting the flow of the solution of H₂O 20 between the two vessels. The second containment vessel 40 has an opening 44 of some sorts on the top portion of the second containment vessel 46. This opening 44 facilitates the addition of additional solution of H₂O 20 to the second containment vessel 40.

The solution of H₂O 20 travels through the connection 42 to the first containment vessel 10 either based off gravity or Bernoulli's principle of fluid dynamics. This flow adds the solution of H₂O 20 to the first containment vessel 10, and if both of the first containment vessel 10 and the second containment vessel 40 are level with one another, adjust the volume of the solution of H20 20 in each vessel so that they are equal.

Furthermore there is a hydrogen extraction point 50 located in the top portion of the first containment vessel 42. The hydrogen extraction point 50 is fashioned into the covering device 18 which is placed over top portion of the first containment vessel 12. Additionally the hydrogen extraction point 50 is, in an alternate embodiment, fashioned into the upper sides of the first containment vessel 16. The hydrogen extraction point 50 is operable to allow hydrogen gas to pass through the point 50. A multitude of devices attach to the hydrogen extraction point 50. One such device is a tubular connection 52 in which the hydrogen gas is led away from the first containment vessel 10. That tubular connection 52 leads to a hydrogen collection station 60 which is another remote containment vessel. Additionally that tubular connection 52, in an additional embodiment, leads to an incendiary device which produces a flame with the extracted hydrogen gas. Furthermore that tubular connection 52, in an additional embodiment, leads to a power generation unit which uses the extracted hydrogen gas as fuel. Moreover that tubular connection 52, in an additional embodiment, leads to an airship device which uses the hydrogen gas for lift and buoyance.

Still referring to FIG. 1, a stirring mechanism 70 is disposed into the interior of the first containment vessel 15. The stirring mechanism 70 extends through the top portion of the first containment vessel 12 and if there is a covering device 18, the stirring mechanism 70 extends through the covering device 18. The bottom end of the stirring mechanism 76 travels through the interior of the first containment vessel 15 and into the solution of H₂O 20 inside the first containment vessel 10.

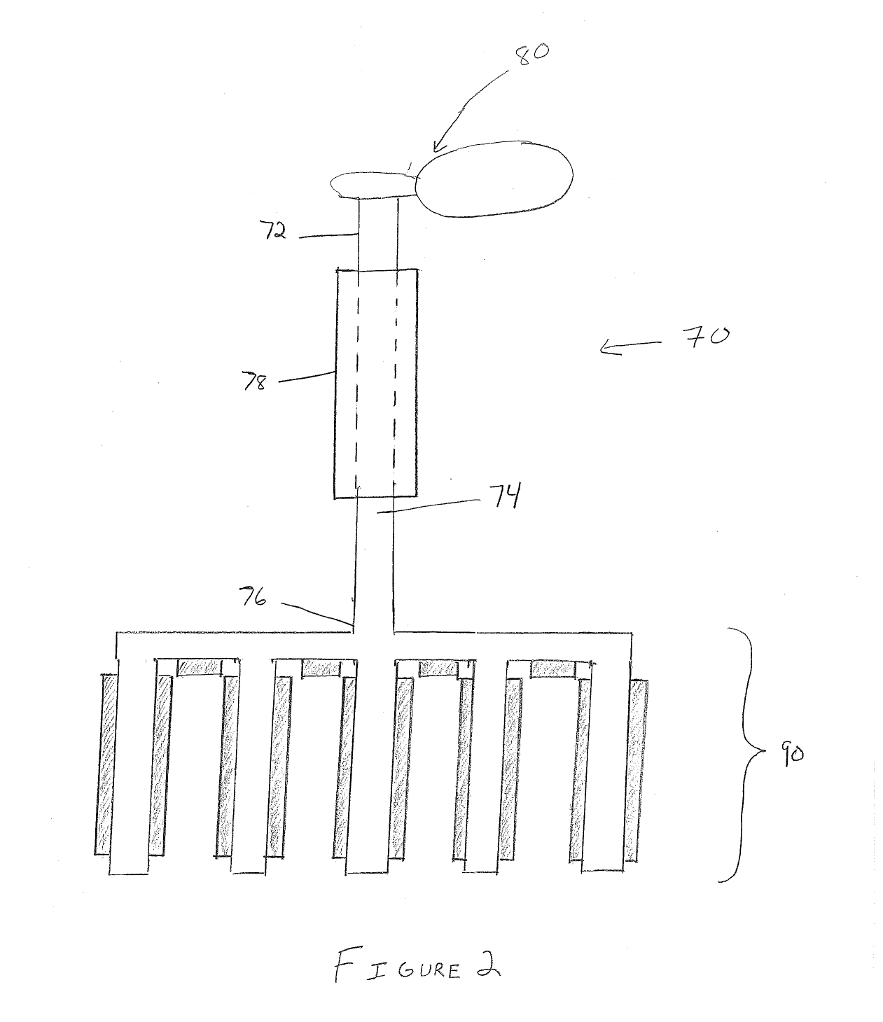

Viewing now FIG. 2, as illustrated, the stirring mechanism 70 is viewed outside of the first containment vessel 10. The stirring mechanism 70, having a top portion of the stirring mechanism 72 is attached to a rotational device 80. This rotational device 80, in an additional embodiment, is a motor of some sorts. The rotational device 80 having at least an on and off operation phase rotates the stirring mechanism 70 when the rotational device 80 is in operation. Rotating the stirring mechanism 70 allows for the entire stirring mechanism 70 to rotate within the first containment vessel 10 and more importantly within the solution of H₂O 20.

Additionally the stirring mechanism 70 has a shaft portion 74. The shaft portion of the stirring mechanism 74 extends from the top portion of the stirring mechanism 72 to the bottom portion of the stirring mechanism 76. The shaft portion of the stirring mechanism 74 is produced from a material sufficient robust so that as the stirring mechanism 70 rotates, and so to the shaft portion of the stirring mechanism 74, the shaft portion of the stirring mechanism 74 will not bend or break during rotation. Additionally, the stirring mechanism 70 is protected by an insulation barrier 78 which encloses around the shaft portion of the stirring mechanism 74. The insulation barrier 78 extends the length of the shaft portion of the stirring mechanism 74 from the top portion of the first containment vessel 12 to below the highest point of the solution of H₂O 20 within the first containment vessel 10. By traveling the length of the shaft portion of the stirring mechanism 74 from the top portion of the first containment vessel 12 to below the highest point of the solution of H₂O 20 within the first containment vessel 10, the insulation barrier 78 creates an effective seal within the first containment vessel 10. This effective seal prevents the escape of produced hydrogen from traveling up the shaft portion of the stirring mechanism 74 and escaping through the top portion of the first containment vessel 12. Instead the released hydrogen travels into the interior of the first containment vessel 15 before traveling to the hydrogen extraction point 50. Because hydrogen is the lightest element and lighter than the air mixture inside the first containment vessel 10, hydrogen attempts to follow the path of least resistance to escape the interior of the first containment vessel 15. By extending the shaft portion of the stirring mechanism 74 into the solution of H₂O 20, a path of greater resistance is offered, and therefore the hydrogen bypasses such a path and flow into the interior of the first containment vessel 15 and in turn the hydrogen extraction point 50.

The stirring mechanism also has a bottom portion 76. Attached to the bottom portion of the stirring mechanism 76 is a wiping device 90. The wiping device 90 contains a multitude of attachments which will be given greater attention later. However, regardless of the formation of the wiping device 90, the wiping device 90 is positioned to be in contact with the metallic or semi-metal material 30. The wiping device 90 then gently rotates as the stirring mechanism 70 rotates. As the wiping device 90 is in contact with the metallic or semi-metal material 30, the wiping device 90 gently brushes the metallic or semi-metal material 30 within the solution of H₂O 20. This gentle brushing removes an impurity buildup on the surface of the metallic or semi-metal material 30 caused by the chemical reaction with the solution of H₂O 20 without damaging or removing any of the surfaces of the metallic or semi-metal material 30. Additionally this wiping device 90 discards the impurity buildups on the surface of the metallic or semi-metal material 30 to allow for the optimal chemical reaction to take place leading to a greater yield of hydrogen gas.

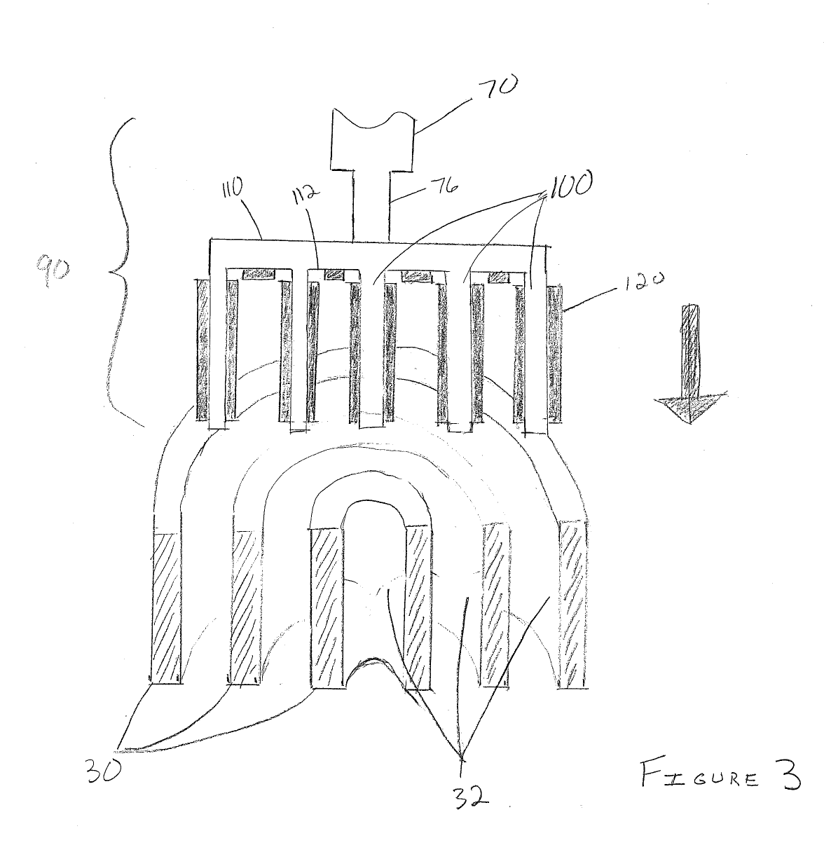

Turning now to FIG. 3, as illustrated, the wiping device 90 is viewed above a metallic or semi-metal material 30. The metallic or semi-metal material is viewed here as a cross section of multiple hollow cylinders stacked within one another. The wiping device 90 viewed in this illustration has a pitchfork shape with multiple prongs 100 extending downward from a support beam 110. The support beam 110 is then attached to the bottom portion of the stirring mechanism 76. Attached on either side of each of the prongs 100 on the pitchfork shaped wiping device 90 are wiping blades 120. These wiping blades 120 are made from a material which has no chemical reaction to either the metallic or semi-metal material 30 or the solution of H₂O 20. Additionally the wiping blades 120 attach to the bottom side of the support beam 110 between the prongs 100 of the pitchfork shaped wiping device 90. Furthermore although the illustrated figure shows wiping blades 120 attached to the wiping device 90 other types of attachments, in alternate embodiments, are used to wipe the metallic or semi-metal material 30. One such wiping attachment is a wiping pad attached to the prongs 100 and the support beam 110 of the pitchfork shaped wiping device 90. The wiping pad is a material which sufficiently removes impurity byproducts from the metallic or semi-metal material 30 while not chemically reacting with either the metallic or semi-metal material 30 or the solution of H20 20. Another type of wiping attachment, in an alternate embodiment, is soft bristles attached to the prongs 100 and the support beam 110 of the pitchfork shaped wiping device 90. The bristles are placed in multiple configuration such as but not limited to extending downward from the support beam 110 as well as extending outward from each side of the prongs 100 coincident with the longitudinal axis of the pitchfork shaped wiping device 90. Additionally, the bristles, in an alternate embodiment, completely surround the support beam 110 and the prongs 100, while extending outward in a pipe cleaner like formation. Finally, the bristles, in an alternate embodiment, surround the prongs 100 of the pitchfork shaped wiping device in a spiral arrangement extending radially outward from the prongs 100 as the spiral moves up and down the prongs.

The pitchfork shaped wiping device 90 is viewed above a cross sectional view of a metallic or semi-metal material 30. The metallic of semi-metal material 30 is a multitude of hollowed cylinders places inside one another. The prongs 100 of the pitchfork shaped wiping device 90 are evenly spaced so that when the stirring mechanism 70 is lowered in the first containment vessel 10 and further the solution of H₂O 20, the prongs 100 of the pitchfork shaped wiping device 90 slide between the walls 32 of the adjacent metallic or semi-metal material 30. With the pitchfork shaped wiping device 90 in place, the cleaning attachments 120 (blades, pads, or bristles) are in gentle contact with the metallic or semi-metal material 30. The rotational device 80 is then placed in an operational mode. In the operational mode the pitchfork shaped wiping device 90 rotates between the hollow cylinders of metallic or semi-metal material 30 gently removing impurity byproducts caused by the chemical reaction of the metallic or semi-metal material 30 and the solution of H₂O 20 while not damaging or removing parts of the metallic or semi-metal material 30 itself.

In FIG. 4 a single wiping blade 200 is viewed attached to the bottom of the support beam 210 forming the wiping device 90. The wiping device 90 is attached to the bottom portion of the stirring mechanism 76. The wiping blade 200 is in gentle contact with the top of the cylinder of metallic or semi-metal material 220 and the support beam 210 rotates to clean away impurity byproducts accumulating on the top surface of the cylinder of metallic or semi-metal material 220 caused from the chemical reaction between the solution of H₂O 20 and the metallic or semi-metal material 30. The wiping blade 200 does not damage or remove parts of the metallic or semi-metal material 30.

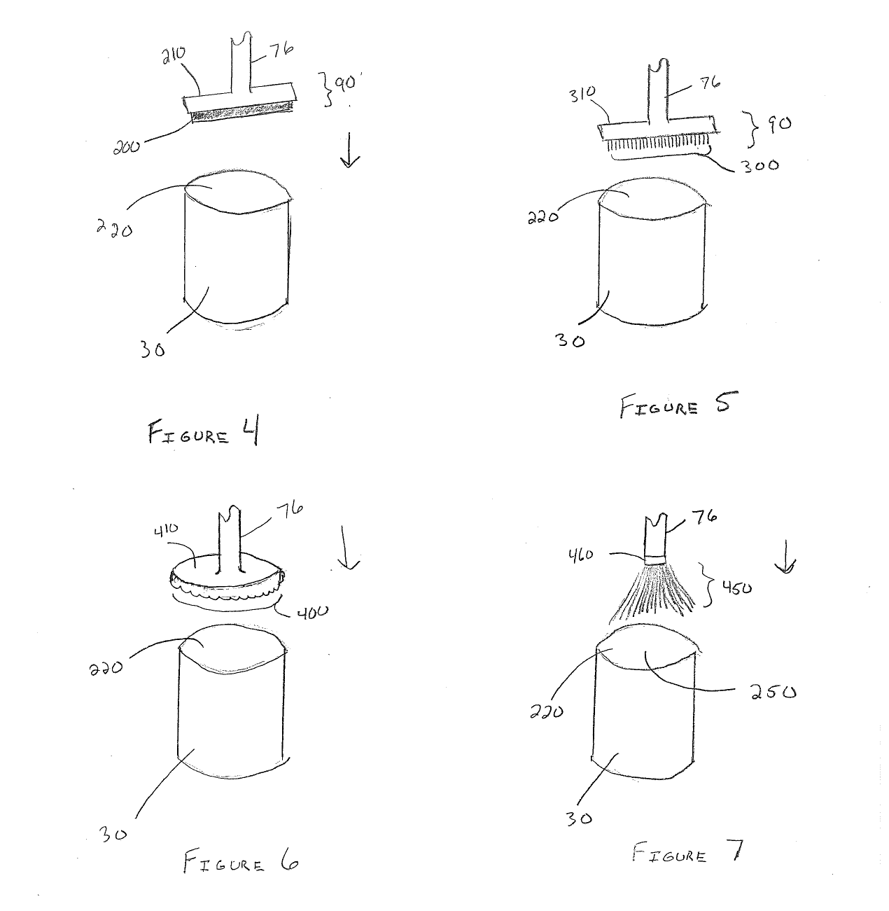

FIG. 5 is an alternate view of the cleaning attachment 120 in which the cleaning attachment 120 is made from bristles 300. The bristles 300 are viewed attached to the bottom of the support beam 310 forming the wiping device 90. The wiping device 90 is attached to the bottom portion of the stirring mechanism 76. The bristles 300 are in gentle contact with the top of the cylinder of metallic or semi-metal material 220 and the support beam 310 rotates to clean away impurity byproducts accumulating on the top surface of the cylinder of metallic or semi-metal material 220 caused from the chemical reaction between the solution of H₂O 20 and the metallic or semi-metal material 30. The bristles 300 do not damage or remove parts of the metallic or semi-metal material 30.

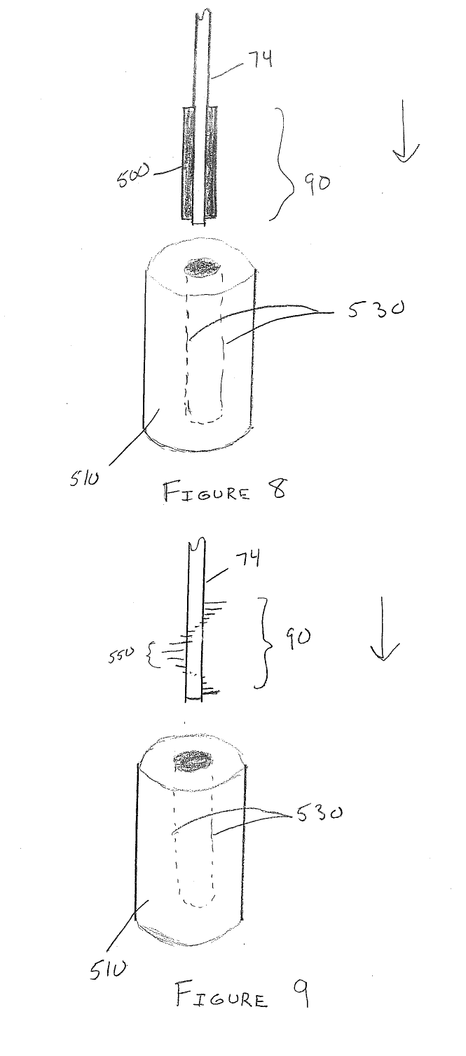

FIG. 6 is an alternate view of the cleaning attachment 120 in which the cleaning attachment 120 is a wiping pad 400. Instead of a support beam, a support disc 410 is shaped and attached to the bottom portion of the stirring mechanism 76. The wiping pad 400 is then attached to the support disc 410 to adequately cover the top surface of the cylinder of metallic or semi-metal material 220. The wiping pad 400 is in gentle contact with the top of the cylinder of metallic or semi-metal material 220 and the support disc 410 rotates to clean away impurity byproducts accumulating on the top surface of the cylinder of metallic or semi-metal material 220 caused from the chemical reaction between the solution of H₂O 20 and the metallic or semi-metal material 30. The wiping pad 400 does not damage or remove parts of the metallic or semi-metal material 30.

FIG. 7 is an alternate view of the cleaning attachment 120 in which the cleaning attachment 120 is a multitude of long thin bristles 450. In this alternate view there is no need for a support beam, instead the multitude of long thin bristles 450 attach to the bottom portion of the stirring mechanism 76 by way of a connection 460. The multitude of long thin bristles 450 is very voluminous and as such fan outwards from one another as they extend further from the connection 460 to the bottom portion of the stirring mechanism 76. The shape of this type of cleaning attachment 120 is similar to that of makeup brushes used in cosmetics. The connection 460 to the bottom portion of the stirring mechanism 76 is then centered over the center of the top surface of the cylinder of metallic or semi-metal material 250. The multitude of long thin bristles 450 is in gentle contact with the top of the cylinder of metallic or semi-metal material 220 and the shaft of the stirring mechanism 74 rotates to clean away impurity byproducts accumulating on the top surface of the cylinder of metallic or semi-metal material 220 caused from the chemical reaction between the solution of H₂O 20 and the metallic or semi-metal material 30. The multitude of long thin bristles 450 does not damage or remove parts of the metallic or semi-metal material 30.

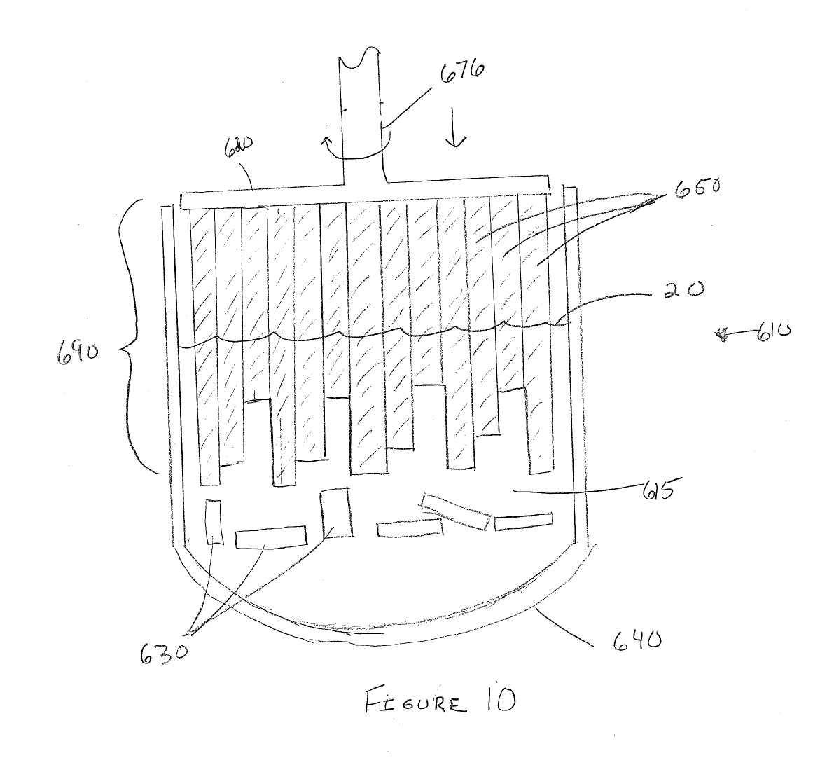

FIG. 8, is an illustration of the wiping device 90 attached as part of the shaft section of the stirring mechanism 74. A wiping device 90 of this type is useful if the metallic or semi-metal material 30 used is a single hollowed out cylinder. FIG. 8 represents the wiping device 90 being wiping blades 500 attached to the sides of the bottom portion of the shaft of the stirring mechanism 74. The shaft of the stirring mechanism 74 and consequently the wiping blades 500 is then placed inside the hollow cylinder of the metallic or semi-metal material 510. The wiping blades 500 are in gentle contact with the sides of the cylinder of metallic or semi-metal material 530 and the shaft of the stirring mechanism 74 rotates to clean away impurity byproducts accumulating on the side surfaces of the cylinder of metallic or semi-metal material 530 caused from the chemical reaction between the solution of H₂O 20 and the metallic or semi-metal material 30. The wiping blades 500 do not damage or remove parts of the metallic or semi-metal material 30.

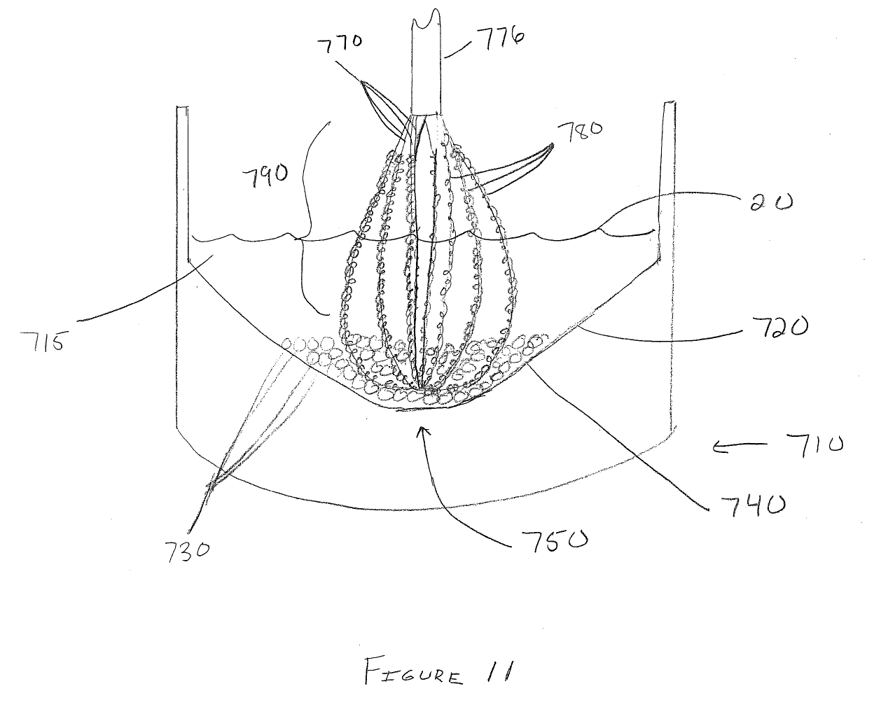

FIG. 9 performs similarly to the device illustrated in FIG. 8, however instead of wiping blades 500 being the wiping device 90 attached to the shaft of the stirring mechanism 74, bristles 550 are attached to the shaft of the stirring mechanism 74. The bristles 550 of the wiping device 90 are arranged in a spiral pattern extending up from the bottom of the shaft of the stirring mechanism 74. Additionally the bristles 550 extend radially outward form the center of the shaft of the stirring mechanism 74.

FIG. 10 is viewed as an additional embodiment of the disclosed system to produce hydrogen gas. The metallic or semi-metal material 630 is placed into the interior of the first containment vessel 610 and rest on the bottom of the first containment vessel 640. No specific shape of the metallic or semi-metal material 630 is necessary for this embodiment to operate as the metallic or semi-metal material 630 is random chunks, or in additional alternate embodiments, a large flat disc, miniature spheres, rectangle or any other possible shape. Additionally the metallic or semi-metal material 630, in an alternate embodiment, is an ingot combination in which hole or punctures are placed into the metallic or semi-metal material. The holes or punctures are filled with a solid caustic so that when water is added to the metallic or semi-metal material 630 in the first containment vessel 610, the caustic dissolves creating a solution of H₂O 20.

The wiping device 690 is attached to the bottom portion of the stirring mechanism 676. Furthermore the wiping device 690 has a support beam 620 extending the length of the first containment vessel 610. Attached to the bottom of the support beam 620 are long strands of fabric 650 the size of a bristle or larger. The envisioned long strands of fabric 650 are similar to those used in soft cloth car washes for cleaning automobiles. When the stirring mechanism 70 is in operation the long strands of fabric 650 drag along the bottom of the first containment vessel 640, gently dragging across the metallic or semi-metal material 630 arranged in the first containment vessel 610. If the first containment vessel 610 is a cylindrical shape, the stirring mechanism 70 rotates and the long strands of fabric 650 follow the rotation of the stirring mechanism 70. If the first containment vessel 610 is of a square or rectangular shape, the stirring mechanism 70 moves the wiping device 690 from one side of the first containment vessel 610 to the opposite side of the first containment vessel 610. The long strands of fabric 650 are in gentle contact with the metallic or semi-metal material 630 as they drag along the bottom of the first containment vessel 640 and gently clean away impurity byproducts accumulating on the surfaces of the metallic or semi-metal material 630 caused from the chemical reaction between the solution of H₂O 20 and the metallic or semi-metal material 630. The long strands of fabric 650 do not damage or remove parts of the metallic or semi-metal material 630.

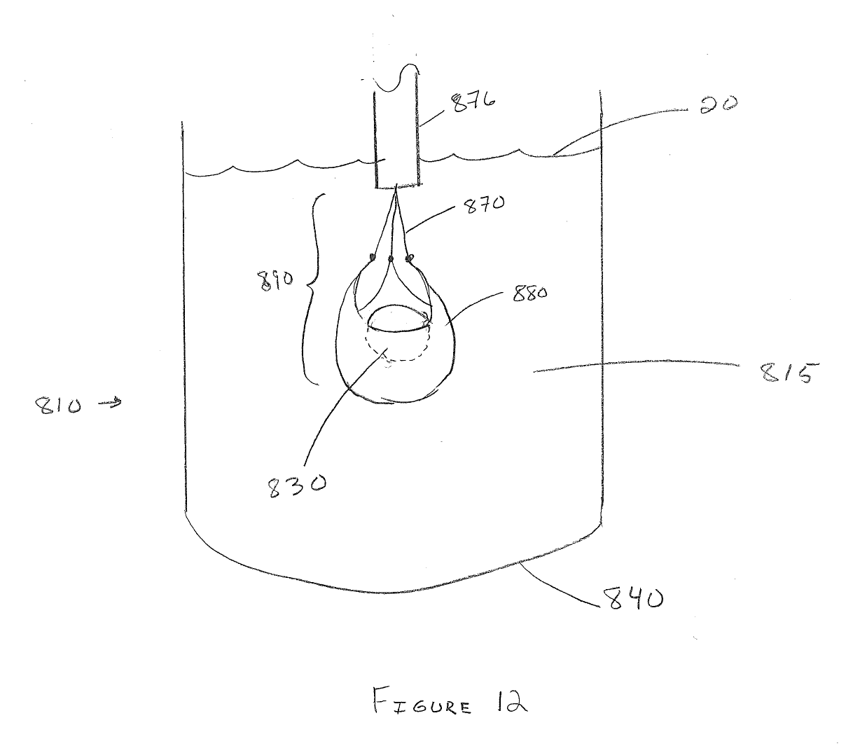

An additional embodiment of the disclosed system to produce hydrogen gas is viewed in FIG. 11. In such an envisioned embodiment, the sides of the first containment vessel 720 are angled inward to converge at the center of the first containment vessel 750. The metallic or semi-metal material 730 is composed of a plurality of miniature pieces or spheres similar to ball bearings. Additionally these pieces or spheres in an alternate embodiment are ingots similar to those described above. A wiping device 790 is attached to the bottom of a stirring mechanism 776. The wiping device 790 has a whisk shape and is centered over the center of the first containment vessel 750 having minimal clearance from the bottom of the first containment vessel 740 and the angled sides of the first containment vessel 720. The metallic or semi-metal spheres 730 pool toward the center of the first containment vessel 750 obscuring the bottom portion of the wiping whisk 790 and resting against the wiping whisk 790. The wiping whisk 790 has a fabric pad covering 780 enveloping the loops 770 which make up the whisk. The fabric pad covering 780 does not chemically react with either the metallic or semi-metallic material 730 or the solution of H₂O 20 which is added to the interior of the first containment vessel 715. When the stirring mechanism 70 is in operation, the fabric pad covering 780 enveloping the loops 770 of the wiping whisk 790 are in gentle contact with the metallic or semi-metal material 730 as the stirring mechanism 70 stirs the metallic or semi-metal spheres 730 and the solution of H₂O 20. As the stirring mechanism 70 stirs, the wiping whisk 790 gently cleans away impurity byproducts accumulating on the surface of the metallic or semi-metal material spheres 730 from the chemical reaction between the solution of H₂O 20 and the metallic or semi-metal material spheres 730. The fabric pad covering 780 enveloping the loops 770 of the wiping whisk 790 do not damage or remove parts of the metallic or semi-metal material spheres 730.

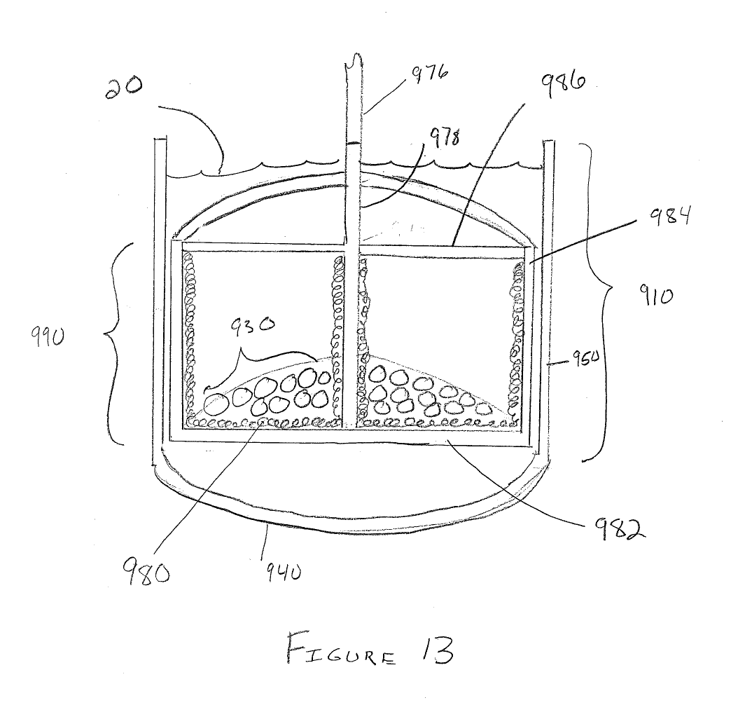

An additional embodiment of the disclosed stirring mechanism 70 in a system to produce hydrogen gas is viewed in FIG. 12. The wiping device 890 attached to the bottom portion of the stirring mechanism 876 has the form of a large surface area cloth or fabric 880 hanging from the bottom portion of the stirring mechanism 876. The large surface area cloth or fabric 880 is attached to the bottom portion of the stirring mechanism 876 by a series of strand connections 870 suspending the large surface area cloth or fabric 880 above the bottom portion of the first containment vessel 840. The large surface area cloth or fabric 880 is made from a material which does not chemically react with the metallic or semi-metal material 830 or the solution of H₂O 20 in the interior of the first containment vessel 815. The large surface area cloth or fabric 880 is placed below the fill line of the solution of H₂O 20 in the interior of the first containment vessel 815. A metallic or semi-metal material 830 or ingot as described above is placed on top of the larger surface area cloth or fabric 880 allowing the large surface area cloth or fabric 880 to fold up onto itself and envelope the metallic or semi-metal material 830. In this alternate embodiment the metallic or semi-metal material 830 or ingots are shaped as a single sphere or multiple miniature spheres similar to ball bearings. As the stirring mechanism 70 stirs, the large surface area cloth or fabric 880 gently cleans away impurity byproducts accumulating on the surface of the metallic or semi-metal material spheres 830 from the chemical reaction between the solution of H₂O 20 and the metallic or semi-metal material spheres 830. The cleaning action is performed by friction between the large surface area cloth or fabric 880 and the metallic or semi-metal material 830 with the additional friction from the metallic or semi-metal material 830 interacting with one another if the metallic or semi-metal material 830 is a plurality of miniature spheres. The large surface area cloth or fabric 880 does not damage or remove parts of the metallic or semi-metal material spheres 830 when the stirring mechanism 70 is in operation.

An additional embodiment of the disclosed stirring mechanism 70 in a system to produce hydrogen gas is viewed in FIG. 13. The wiping device 990 attached to the bottom portion of the stirring mechanism 976, is a large insert which is placed snuggly inside the first containment vessel 910. In this additional embodiment the first containment vessel 910 is a cylindrical shape. The overall shape of the wiping device 990 is also cylindrical. The wiping device 990 has a shaft extension 978 running from the bottom portion of the stirring mechanism 976 to the base of the wiping device 982. The base of the wiping device 982 is a common surface extending radially outward from the shaft extension 978 and forms a disc shape on the bottom of the first containment vessel 940. Sides of the wiping device 984 extend up the sides of the first containment vessel 950 while still being part of one unit attached to the base of the wiping device 982. Multiple supporting beams 986 are available to structurally support the wiping device 990 which runs the length of the diameter of the wiping device 990 and through the shaft extension 978 in the middle of the wiping device 990. The support beams 986 are attached to the shaft extension 978 of the wiping device 990.

The base of the wiping device 982 and the sides of the wiping device 984 are covered which a fabric pad 980 for cleaning purposes. The fabric pad 980, in an alternate embodiment, is instead bristles or the like. Additionally the shaft extension 978, in an alternate embodiment, is covered by the fabric pad 980 for additionally cleaning surface area. A metallic or semi-metal material 930 or ingot is then placed into the first containment vessel 910 and resting on top of the fabric pad covered base of the wiping device 982. In the alternation embodiment, the metallic or semi-metal materials 930 comprise a multitude of miniature spheres or ingots. A solution of H₂O 20 is then added to the first containment vessel 910. As the stirring mechanism 70 stirs, the fabric covered sides 984 and base of the wiping device 982 gently cleans away impurity byproducts accumulating on the surface of the metallic or semi-metal material spheres 930 from the chemical reaction between the solution of H₂O 20 and the metallic or semi-metal material spheres 930. The cleaning action is performed by friction between the fabric covered sides 984 and base of the wiping device 982 and the metallic or semi-metal material 930, and from the additional friction created by the metallic or semi-metal material 930 interacting with one another. The fabric covered sides 984 and base of the wiping device 982 does not damage or remove parts of the metallic or semi-metal material spheres 930 when the stirring mechanism 70 is in operation.

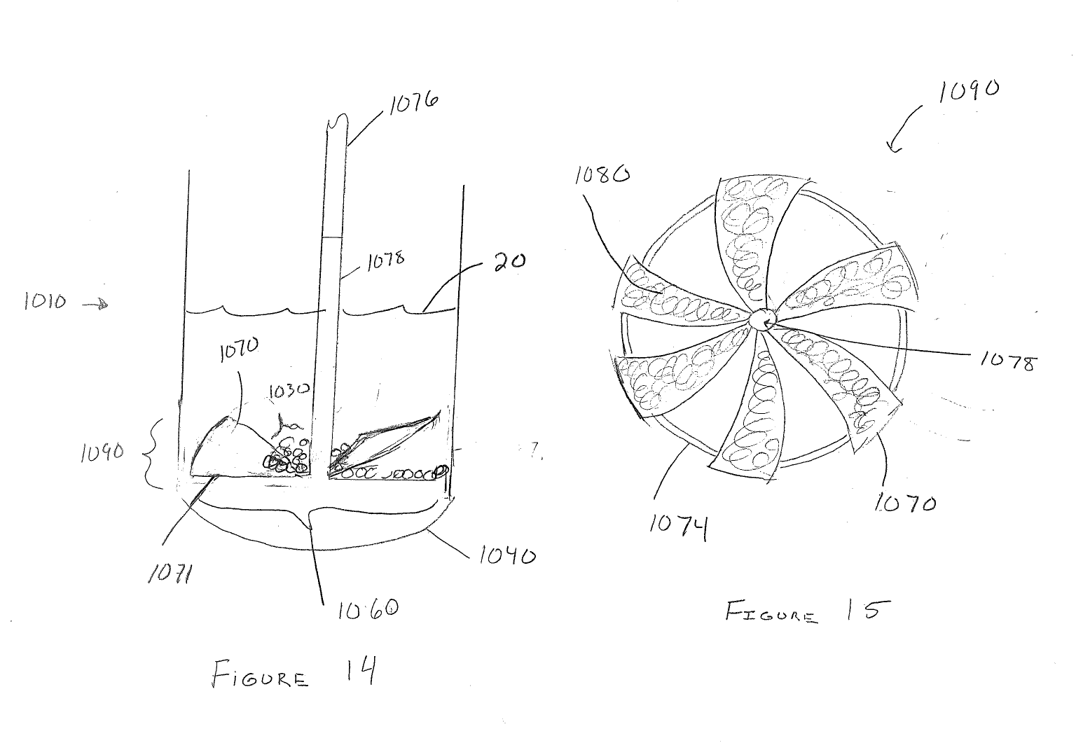

An additional embodiment of the disclosed stirring mechanism 70 in a system to produce hydrogen gas is viewed in FIG. 14. The wiping device 1090 attached to the bottom portion of the stirring mechanism 1076, is a large insert which is placed snuggly inside the first containment vessel 1010. In this additional embodiment the first containment vessel 1010 is a cylindrical shape. The overall shape of the wiping device 1090 is also cylindrical. The wiping device 1090 has a shaft extension 1078 running from the bottom portion of the stirring mechanism 1076 to the base of the wiping device 1060. The base of the wiping device 1060 is a surface extending radially outward from the shaft extension 1078 and forms a fan shape on the bottom of the first containment vessel 1040. The blades 1070 of the fan shaped base 1060 angle upward from the bottom of the first containment vessel 1040 towards the top of the first containment vessel 1010. Each of the fan blades 1070 of the fan shaped base 1060 are attached to the shaft extension 1078 as well as an outer support ring 1074 following the circumference of the first containment vessel 1010. The bottom edges 1071 of each fan blade 1070 extends radially from the shaft extension 1078 to the outer support ring 1074 and are in light contact with the bottom of the first containment vessel 1040.

The fan blades 1070 of the wiping device 1090 are covered which a fabric pad 1080 for cleaning purposes as depicted in FIG. 15. The fabric pad 1080, in an alternate embodiment, is instead bristles or the like. Additionally the shaft extension 1078, in an alternate embodiment, is covered by the fabric pad 1080 for additionally cleaning surface area. A metallic or semi-metal material 1030 or ingot is then placed into the first containment vessel 1010 and resting on top of the fabric pad covered fan blades 1070 of the wiping device 1090. In the alternate embodiment, the metallic or semi-metal material 1030 is a multitude of miniature spheres or ingots. A solution of H₂O 20 is then added to the first containment vessel 1010. As the stirring mechanism 70 stirs, the fabric covered fan blades 1070 gently rotate lifting the metallic or semi-metal material 1030 upward along their angled surface. The fabric covered fan blades 1070 gently clean away impurity byproducts accumulating on the surface of the metallic or semi-metal material spheres 1030 from the chemical reaction between the solution of H₂O 20 and the metallic or semi-metal material spheres 1030. The cleaning action is performed by friction between the fabric covered fan blades 1070 and the metallic or semi-metal material 1030, and from the additional friction created by the metallic or semi-metal material 1030 interacting with one another. The fabric covered fan blades 1070 do not damage or remove parts of the metallic or semi-metal material 1030 spheres when the stirring mechanism 70 is in operation.

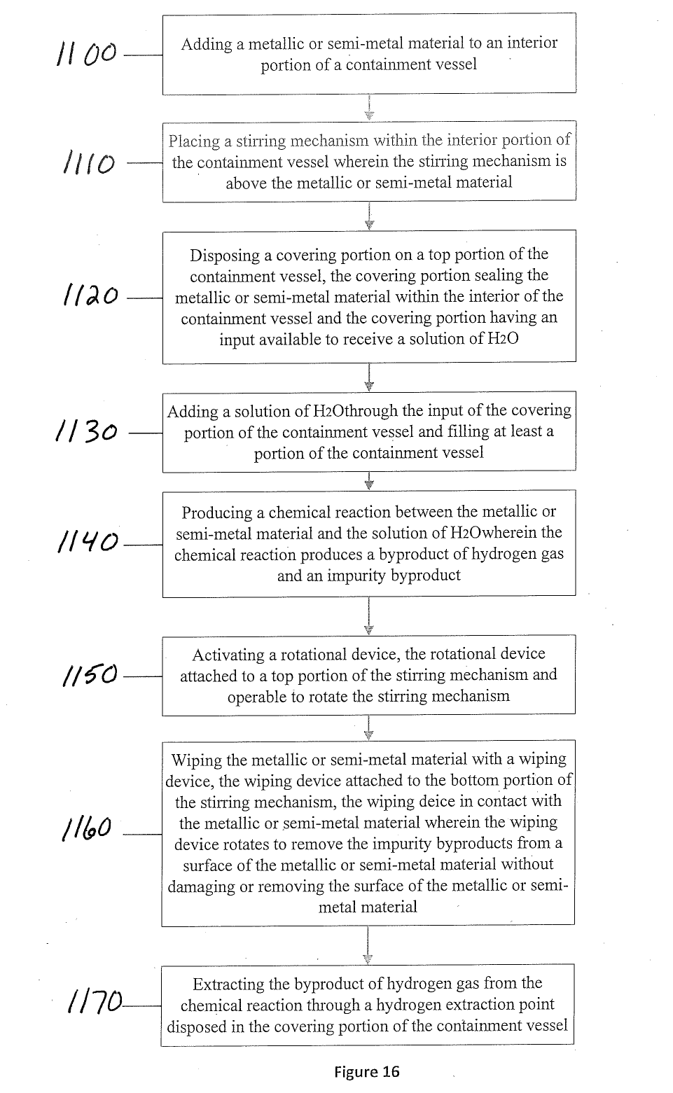

Referring now to FIG. 16, an exemplary succession of steps which are used to produce hydrogen gas from the disclosed hydrogen extraction system is shown. In block 1100, a metallic or semi-metal material 30 is added to the base of a first containment vessel 10. As stated above the metallic or semi-metal material 30 is fashioned from a multitude of different compositions or is an ingot formation. Block 1110, views a stirring mechanism 70 placed as well into the interior of the first containment vessel 15. The stirring mechanism 70 is in gently contact with the metallic or semi-metal material 30, so that when the stirring mechanism 70 operates, the stirring mechanism 70 will gently remove impurity byproducts from the produced chemical reaction without damaging the metallic or semi-metal material 30. Then in block 1120, a covering portion 18 is placed on top of the top portion of the first containment vessel 12 with the stirring mechanism 70 running through and anchored to the covering portion 18 of the first containment vessel 10. Next as viewed in block 1130, a solution of H₂O 20 which contains H₂O and a caustic is added to the first containment vessel 10 through an opening in either the covering portion 18 or the top portion of the first containment vessel 12. Once the solution of H₂O 20 comes in contact with the metallic or semi-metal material 30 seen in block 1140, a chemical reaction occurs which creates both impurity byproducts as well as hydrogen gas. Additionally, once the first containment vessel 10 is filled with the solution of H₂O 20, a rotational device 80 attached to the top portion of the stirring mechanism 72 is activated causing the stirring mechanism 70 to rotate seen in block 1150. In block 1160, the wiping device 90 attached at the bottom portion of the stirring mechanism 76, gently wipes the metallic or semi-metal material 30 as the stirring mechanism 70 rotates as to not damage or remove pieces of the metallic or semi-metal material 30. The wiping device 90 only removes impurity byproducts from the surface of the metallic or semi-metal material 30 and does not damage this metallic or semi-metal material 30. In block 1170, the hydrogen gas from the chemical reaction fills the interior of the first containment vessel 15. The hydrogen gas is released from the interior of the first containment vessel 15 into a hydrogen collection station 60 through a hydrogen extraction point 50 located in the covering portion 18 disposed across the top portion of the first containment vessel 12.

### INDUSTRIAL APPLICABILITY

From the foregoing, it may be appreciated that the system of collecting gaseous hydrogen disclosed herein may have industrial applicability in a variety of setting such as, but not limited to, use in the commercial manufacture of hydrogen. Such disclosed system of collecting gaseous hydrogen may also be used, for example in powering hydrogen based machinery such as cars, aircraft or generators, or in military applications for generating power, operating vehicles, or filling airships and balloons.

Additionally in the field of hydrogen collection, such system for collecting gaseous hydrogen involves materials and containment which can be easily transported from location to location with great ease and for multiple uses. Furthermore, the materials used in such system for collecting gaseous hydrogen do not react chemically with each other and are stable when transported and not in combination to produce the hydrogen. While the system for collecting gaseous hydrogen is active, continuous wiping of the metallic component allows for the maximized chemical reaction with the caustic solution so that the optimal amount of hydrogen being produced. By removing unnecessary byproduct buildup on the metallic component, less energy is used to produce gaseous hydrogen as well and allowing the maximum amount of chemical reaction with the most minimal amount of obtrusive waste.

While the foregoing detailed description has addressed only specific embodiments, it is to be understood that the scope of the disclosure is not intended to be limiting. Thus, the breadth and spirit of this disclosure is intended to be broader than any of the embodiments specifically disclosed and/or encompassed within the claims appended hereto.

1. A stirring mechanism used in a system to collect hydrogen gas, the stirring mechanism comprising:
a top connection of the stirring mechanism, the top connection of the stirring mechanism attached to a rotational device, the rotational device powered to rotate the stirring mechanism;
a shaft portion of the stirring mechanism, the shaft portion of the stirring mechanism protected by a barrier, the barrier extending the length of the shaft portion of the stirring mechanism;
a wiping device, the wiping device attached to a bottom of the stirring mechanism, wherein the wiping device is positioned to be in contact with a metallic or semi-metal material when the stirring mechanism rotates; and
the wiping device operative to remove an impurity buildup on a surface of the metallic or semi-metal material without damaging or removing the surface of the metallic or semi-metal material.

2. The stirring mechanism according to claim 1, wherein the wiping device has a cleaning instrument attached to the wiping device.

3. The stirring mechanism according to claim 2, wherein the cleaning instrument is a fabric pad, bristles, or a wiping blade.

4. The stirring mechanism according to claim 1, wherein the metallic or semi-metal material has a cavity or a plurality of cavities formed into the metallic or semi-metal material, the cavity of the plurality of cavities being formed to contain a caustic.

5. The stirring mechanism according to claim 1, wherein the wiping device is formed from a support beam attached to the shaft portion of the stirring mechanism and a plurality of prongs extending downward from the support beam.

6. The stirring mechanism according to claim 5, wherein a cleaning instrument is attached to the prongs of the wiping device and a bottom portion of the support beam.

7. The stirring mechanism according to claim 1, wherein the wiping device is formed on a extended shaft portion of the stirring mechanism, the wiping device having a cleaning instrument attached to the extended shaft portion of the stirring mechanism.

8. The stirring mechanism according to claim 1, wherein the wiping device is formed from a support beam attached to the shaft portion of the stirring mechanism, a cleaning instrument is attached to a bottom portion of the support beam and hangs in a vertically downward fashion.

9. The stirring mechanism according to claim 1, wherein the wiping device is formed in a support whisk shape, the support whisk shape having a cleaning instrument attached to a plurality of whisk loops forming the support whisk shape.

10. The stirring mechanism according to claim 1, wherein the wiping device is formed by a supporting cylinder insert, the supporting cylinder insert having a shaft extension traveling from the bottom of the shaft of the stirring mechanism to a circular base of the supporting cylinder insert, the circular base of the supporting cylinder insert having an outer wall attached to the circumference of the circular base of the supporting cylinder insert and extending upward and a cleaning instrument attached to the circular base of the supporting cylinder insert and an inward facing surface of the outer wall.

11. The stirring mechanism according to claim 1, wherein the wiping device is formed from a large surface area cleaning instrument, the large surface cleaning instrument connected to the shaft portion of the stirring mechanism by a plurality of connection strands and configured to suspend the metallic or semi-metal material by gravity within the large surface are cleaning instrument.

12. The stirring mechanism according to claim 1, wherein the wiping device is formed by a supporting fan insert, the supporting fan insert having a shaft extension traveling from the bottom of the shaft of the stirring mechanism to a plurality of fan blades positioned at the bottom of the shaft extension extending radially outward from the shaft extension, the plurality of fan blade configured to angle upward from the base of the shaft extension and an outer support ring connecting the plurality of fan blades of the supporting fan to the circular base of the supporting cylinder insert.

13. An system to extract and capture hydrogen gas, the system comprising:
a first containment vessel;
a hydrogen extraction point located on the first containment vessel;
a solution of H20, the solution of H20 filling at least part of an interior of first containment vessel;
a metallic or semi-metal material, the metallic or semi-metal material placed inside the interior of the first containment vessel and covered by the solution of H20 wherein a surface of the metallic or semi-metal material chemically reacts with the solution of H20 producing at least a hydrogen gas byproduct;
a stirring mechanism, the stirring mechanism disposed into the interior of the first containment vessel and into the solution of H20, the stirring mechanism comprising:
a top connection of the stirring mechanism;
a shaft portion of the stirring mechanism, the shaft portion of the stirring mechanism extending from the top connection of the stirring mechanism to a bottom connection of the stirring mechanism; and
a wiping device, the wiping device attached to the bottom connection of the stirring mechanism wherein the wiping device is positioned to be in contact with metallic or semi-metal material, the wiping device operative to remove an impurity buildup on the surface of the metallic material without damaging or removing the surface of the metallic material.

14. The system to extract and capture hydrogen gas according to claim 13, wherein the first containment vessel has a top portion and a bottom portion, the bottom portion being solid and part of the first containment vessel, the top portion having a covering device to enclose the first containment vessel.

15. The system to extract and capture hydrogen gas according to claim 14, wherein the shaft portion of the stirring mechanism is protected by an insulation barrier, the insulation barrier extending the length of the shaft portion of the stirring mechanism from the covering device of top portion of the first containment vessel to below the highest point of the aqueous solution within the first containment vessel.

16. The system to extract and capture hydrogen gas according to claim 14, wherein the stirring mechanism extends through the covering device of the top portion of the first containment vessel.

17. The system to extract and capture hydrogen gas according to claim 14, wherein the hydrogen extraction point is positioned in the covering device of the top portion of the first containment vessel and operable to allow the hydrogen gas byproduct to flow through the hydrogen extraction point and into a remote collection chamber or a hydrogen operable device.

18. The system to extract and capture hydrogen gas according to claim 13, wherein the solution of H20 contains at least water and a caustic.

19. The system to extract and capture hydrogen gas according to claim 13, wherein the top connection of the stirring mechanism attaches to a rotational device powered to turn the stirring mechanism within the solution of h20 inside the first containment vessel, the wiping device powered by the rotational device to remove the impurity buildup on the surface of the metal or semi-metal material when the stirring mechanism rotates.

20. The system to extract and capture hydrogen gas according to claim 13, wherein a second containment vessel is disposed remotely from the first containment vessel, the second containment vessel being connected to the first containment vessel by a tubular connection, the tubular connection allowing for the follow of the solution of H20 between the first containment vessel and the second containment vessel.

21. A method or extracting and capturing hydrogen gas, the method comprising:
adding a metallic of semi-metal material to an interior portion of a containment vessel;
placing a stirring mechanism within the interior portion of the containment vessel wherein the stirring mechanism is above the metallic or semi-metal material;
disposing a covering portion on a top portion of the containment vessel, the covering portion sealing the metallic or semi-metal material within the interior of the containment vessel and the covering portion having an input available to receive a solution of H20;
adding the solution of H20 through the input of the covering portion of the containment vessel and filling at least a portion of the containment vessel;
producing a chemical reaction between the metallic or semi-metal material and the solution of H20 wherein the chemical reaction produces a byproduct of hydrogen gas and an impurity byproduct;
activating a rotational device, the rotational device attached to a top portion of the stirring mechanism and operative to rotate the stirring mechanism;
wiping the metallic or semi-metal material with a wiping device, the wiping device attached to the bottom portion of the stirring mechanism, the wiping device in contact with the metallic or semi-metal material wherein the wiping device rotates to remove the impurity byproducts from a surface of the metallic or semi-metal material without damaging or removing the surface of the metallic or semi-metal material while the stirring mechanism rotates;
extracting the byproduct of hydrogen gas from the chemical reaction through a hydrogen extraction point disposed in the covering portion of the containment vessel.
